(19) United States
(12) Patent Application Publication
(10) Pub. No.: US 2010/0220814 A1
(43) Pub. Date: Sep. 2, 2010

(54) METHOD AND APPARATUS FOR SPATIAL TEMPORAL TURBO CHANNEL CODING/DECODING IN WIRELESS NETWORK

(75) Inventors: Gang Wu, Shanghai (CN); Yueheng Li, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/993,073

(22) PCT Filed: Jun. 21, 2006
(86) PCT No.: PCT/IB2006/052000

§ 371 Date: Dec. 19, 2007

(30) Foreign Application Priority Data
Jun. 24, 2005 (CN) 200510079117.4

(51) Int. Cl. H04L 27/00; H04L 27/20

(52) U.S. Cl. 375/308; 375/295; 375/340

(57) ABSTRACT

The present invention proposes a channel encoder, and a channel encoding method executed by the channel encoder comprising the steps of: (a), converting the serial data stream to be encoded into multiple parallel signals; (b). interleaving the multiple parallel signals; (c). according to predefined encoding rule, encoding the multiple parallel signals and interleaved multiple parallel signals separately to obtain encoded multiple parallel signals; and (d). transmitting the interleaved multiple parallel signals and the multiple parallel signals via multiple Tx antenna cyclically and alternately. The channel encoder according to the present invention can achieve better decoding performance at receiver due to the combination of Turbo encoding scheme.

### FIELD OF THE INVENTION

The present invention relates generally to a method and apparatus for channel coding/decoding in wireless network, and more particularly, to a method and apparatus for spatial temporal Turbo channel coding/decoding.

### BACKGROUND OF THE INVENTION

With the increasing popularization of mobile communication, the mobile communication service with only voice service can not satisfy the demands for information collection any more, and the mobile data communication service has exhibited its huge and promising prospect with its more convenient and more abundant information contents e.g. business and entertainment. Therefore, the high speed packet access service that supports high speed data transmission, especially the high speed downlink packet access (HSDPA) from a base station to a user terminal, has become one of key targets of future wireless communication systems.

However, with the growing development of wireless communication, the available limited resources of frequency band, time slot and spreading codes are nearly consumed up and if the data transmission rate needs further enhancement, one solution is to appropriately utilize the resource of spatial field. Multiple Input Multiple Output (MIMO) that was proposed recently is exactly the technique that utilizes multiple transmit and receive antennas to construct multiple parallel wireless channels in spatial field, so as to fully exploit the spatial resource to improve the data transmission speed. Among existing MIMO technologies, Bell Lab Layered Space Time (BLAST) technique is a typical one with the capability to dramatically improve data transmission speed.

BLAST technique has multiple architectures, wherein the BLAST architecture without any channel coding can achieve the maximum utilization of spatial channels to transmit data thanks to no redundancy information in transmitted signal. However, it is pitiful that the quality of transmitted signal based on this BLAST architecture is not satisfactory. In order to improve QoS (Quality of Signal), channel coding and BLAST technique may be combined to realize multiple parallel transmissions and meanwhile guarantee the QoS to some extent. Nevertheless, the BLAST architecture depends on the utilization of non-correlation among spatial channels to demodulate multiple data, therefore the number of receive antennas in the receiver must be larger or equal to that of transmit antennas, only by which can the substream data based on the spatial characteristics of MIMO channel be separated. However, for user terminals in the receiving side, the number of the receive antenna is limited by weight, size and battery consumption requirement in the terminal, therefore normally cannot meet the requirements of BLAST technique. In many cases, there is only one receiver antenna provided. So, even though the BLAST technique can considerably improve the data transmission speed, it is not suitable to be used to provide HSDPA due to its excessive requirements for multiple antennas and multiple RF (Radio Frequency) units in the receiver.

Except BLAST, other MIMO techniques for 3GPP system are also proposed recently, e.g., Per Antenna Rate Control (PARC), Rate Control Multipath Diversity (RC MPD) and Double Space Time Transmit Diversity Sub-Group Rate Control (DSTTD-SGRC), etc. However, similarly, all above MIMO techniques also require multiple receive antennas during terminal processing. In view of terminal implementation and cost, they are not suitable for downlink high speed transmission either.

Based on the above analysis, although the above MIMO techniques can realize high-speed data transmission, their application fields are limited by the requirement of the number of receive antennas in user terminal.

In order to solve the above problem, a solution is disclosed in the china patent application named “method and apparatus for spatial channel coding/decoding in parallel transmission” and filed by KONINKLIJKE PHILIPS ELECTRONICS N.V. on Aug. 9, 2004, Application Serial No. 200410056552.0, and incorporated herein by reference. According to the Spatial Channel Code (SCC) method proposed in the patent application, channel coding and multipath parallel architecture are combined to correlate multipath parallel signals and demodulate the multipath parallel signals in user terminal of the receiving side by inserting some redundancy information between the multipath parallel signals, so as to realize high speed data transmission under the condition of only one receiver antenna or the limited number of receiver antennas.

When mainly applied to voice transmission, SCC can acquire better performance compared with other MIMO technologies. However, since SCC is still limited to the usage of convolutional coding, although its structure is relatively simple, its BER (Bit Error Rate) is nevertheless relatively high when carrying huge-bulk of high speed data traffic, and therefore QoS is considerably affected.

Therefore, it is necessary to propose a better MIMO solution to ensure high transmission data rate and satisfactory QoS under the condition of only one receive antenna or the limited number of receive antennas.

### OBJECT AND SUMMARY OF THE INVENTION

An object of the present invention is to provide a method and apparatus for spatial temporal Turbo channel coding/decoding in wireless network, which enables a user terminal employing the method and apparatus to realize both high speed transmission and satisfactory QoS simultaneously under the condition of only one receive antenna or the limited number of receive antennas.

According to a channel coder of the present invention, the channel coding method executed by the channel coder, comprising the steps of: a). Converting serial signals to be encoded to multiple parallel signals; (b). Interleaving the multiple parallel signals; (c). Encoding the multiple parallel signals and the interleaved multiple parallel signals respectively according to a predefined coding rule, to acquire encoded multiple parallel signals; and (d). Transmitting the encoded multiple parallel signals and the multiple parallel signals circularly and alternately via multiple transmit antennas.

According to a channel decoder of the present invention, the channel decoding method executed by the channel decoder comprising the steps of: a). Demultiplexing encoded multiple parallel signals received via at least one receive antenna; b). Performing channel estimation on multiple wireless channels on which the encoded multiple parallel signals are transmitted; and (c). Performing recursive decoding on the demultiplexed encoded multiple parallel signals by using the channel estimation result and according to a predefined decoding rule.

The method and apparatus for channel coding/decoding in the present invention can achieve better decoding performance due to the combination of Turbo encoding scheme.

Other objects and attainments together with a fuller understanding of the invention will become apparent and appreciated by referring to the following description and claims taken in conjunction with the accompanying drawings.

### BRIEF DESCRIPTION OF THE INVENTION

Detailed descriptions will be given below to the present invention in conjunction with specific embodiments and accompanying drawings, in which:

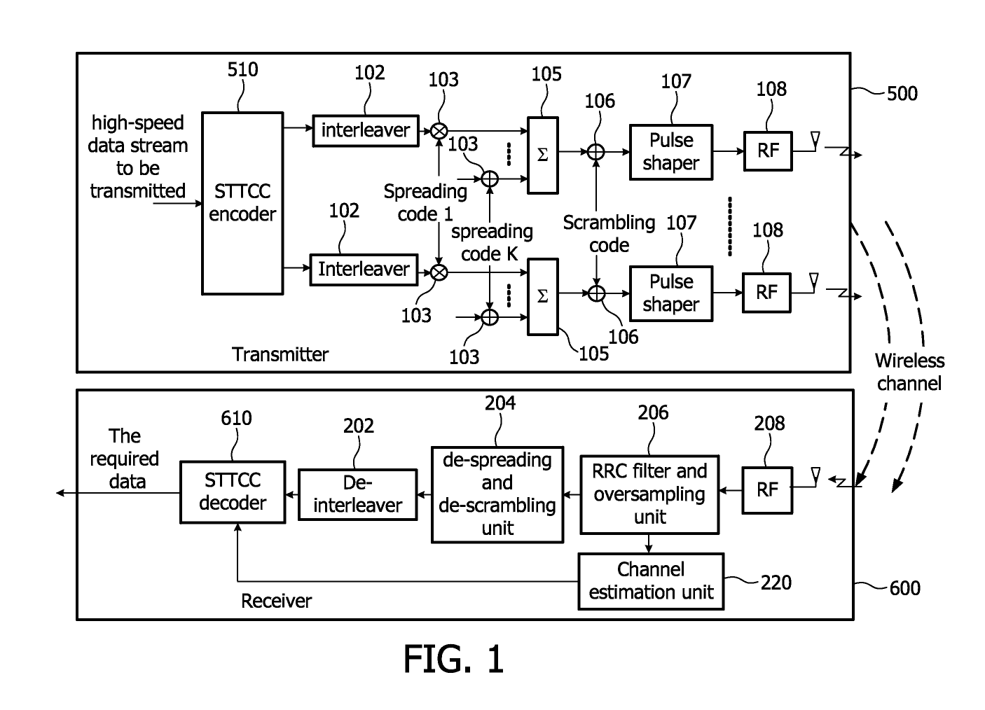

FIG. 1 is a schematic diagram illustrating the structures of the transmitter and receiver adopting spatial temporal Turbo Channel Coding/Decoding according to one embodiment of the present invention, wherein the transmitter has multiple transmit antennas while the receiver has only one receive antenna;

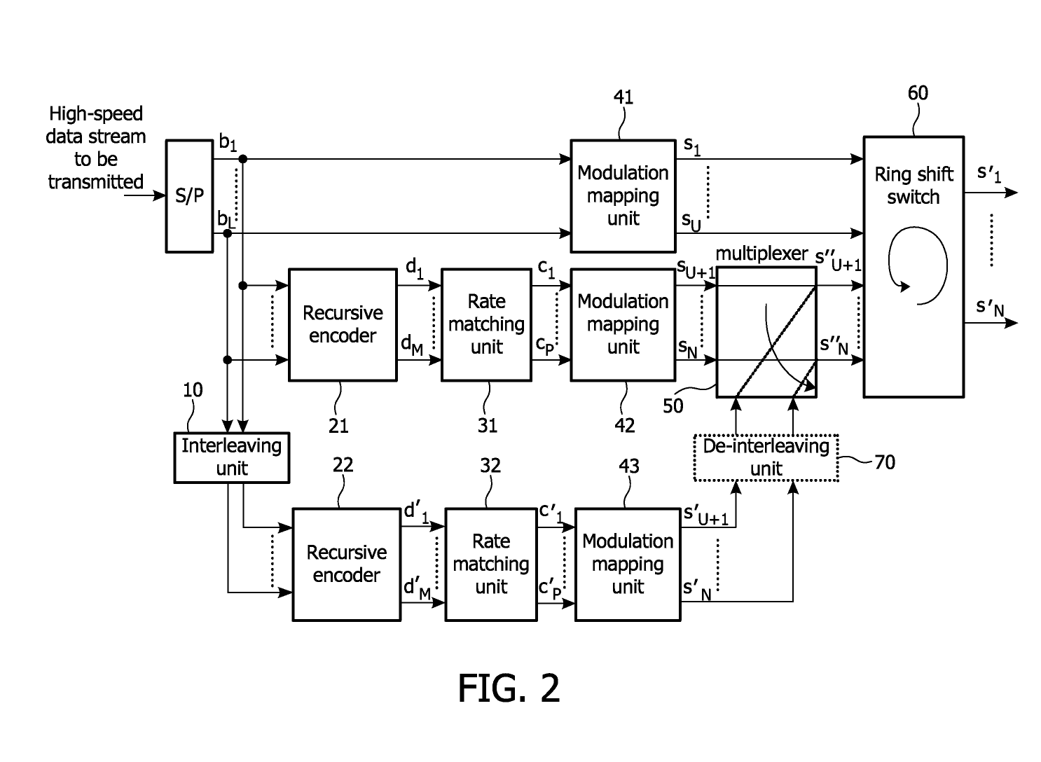

FIG. 2 is a functional block diagram illustrating a STTCC encoder according to the present invention;

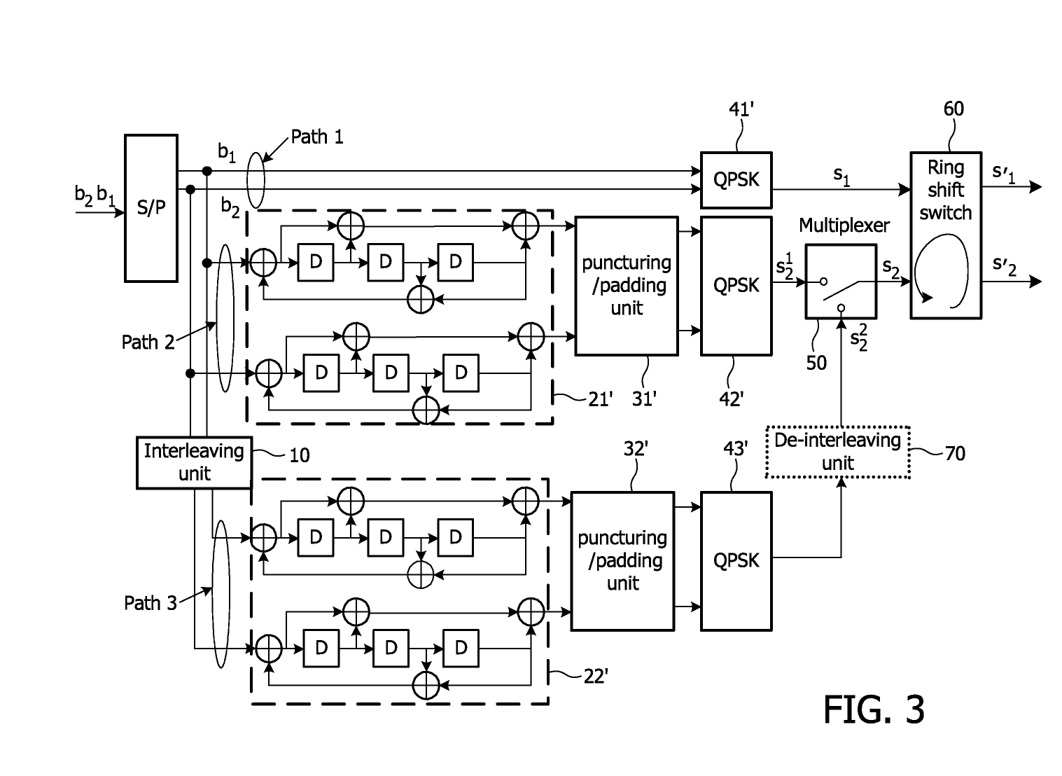

FIG. 3 is a block diagram illustrating the detailed structure of a STTCC encoder designed according to the functional block diagram shown in FIG. 2

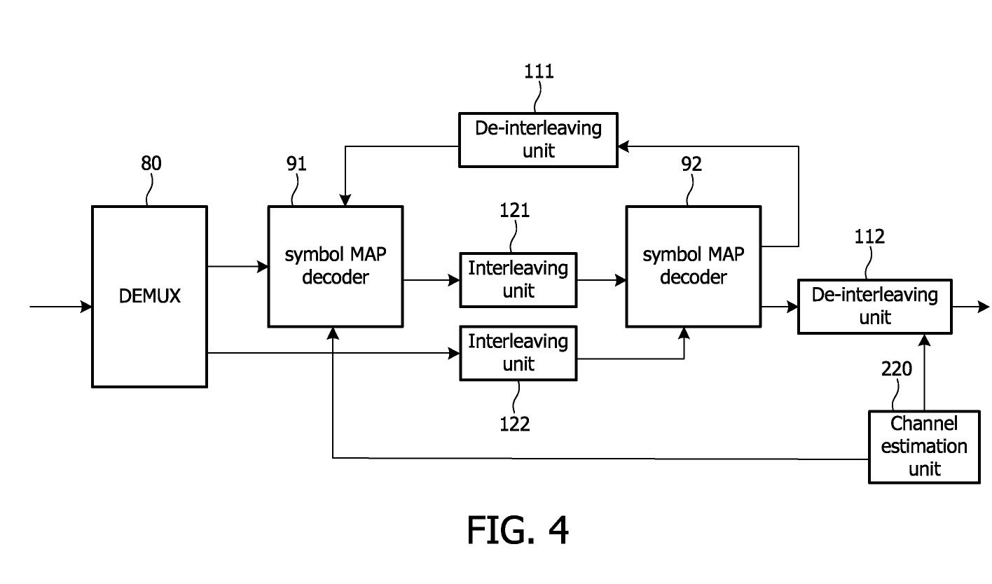

FIG. 4 is a functional block diagram illustrating a STTCC decoder corresponding to the STTCC encoder shown in FIG. 2

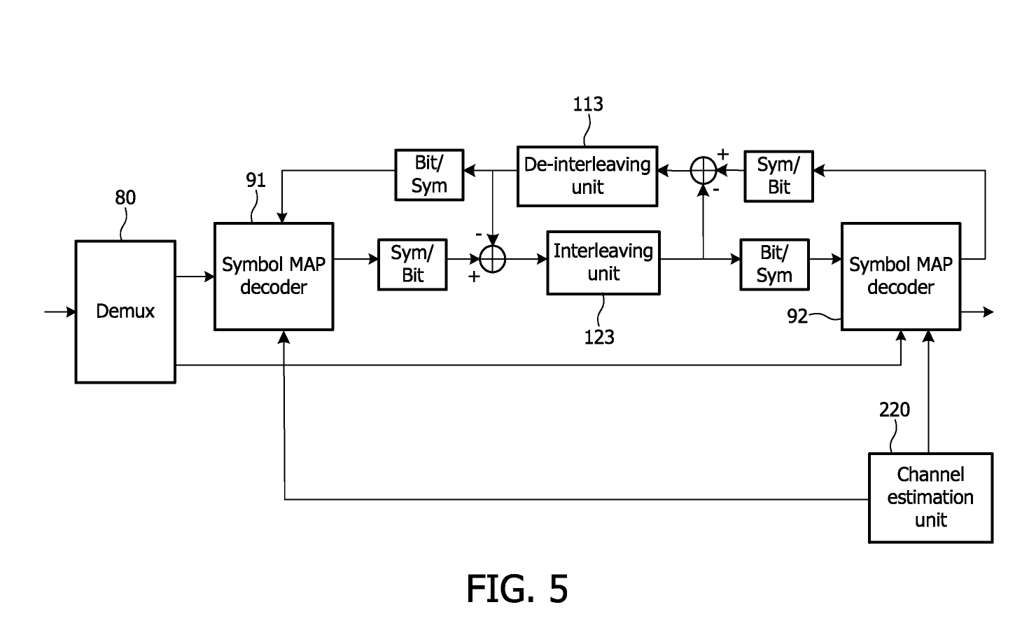

FIG. 5 is a functional block diagram illustrating another STTCC decoder corresponding to the STTCC encoder shown in FIG. 2

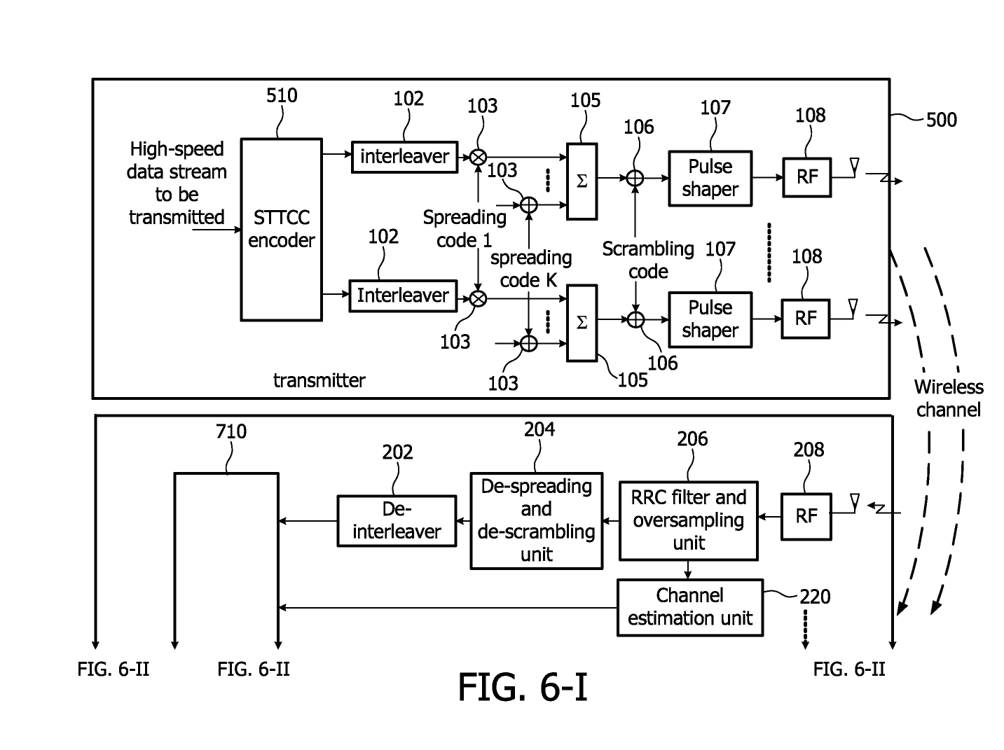

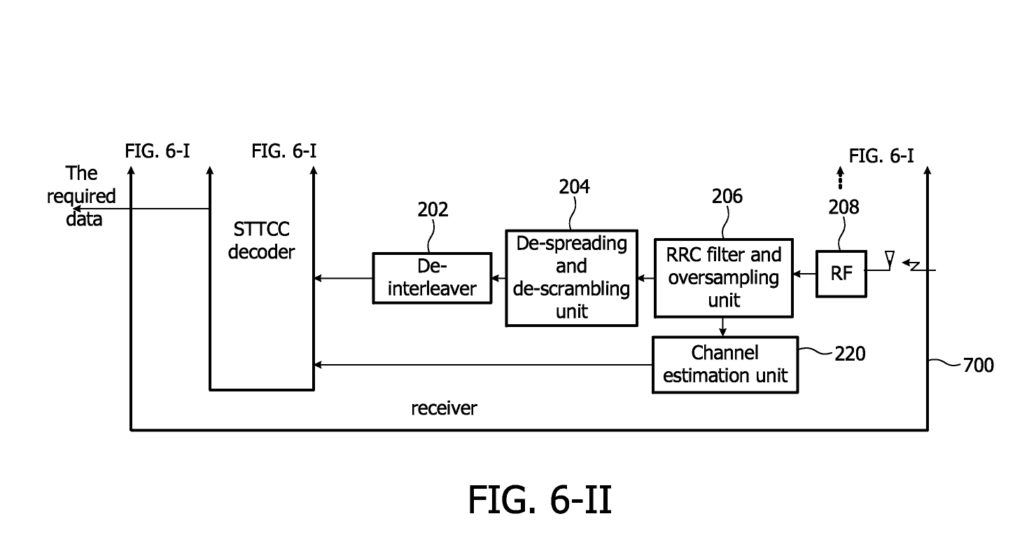

FIG. 6 is a schematic diagram illustrating the structure of the transmitter and receiver adopting spatial temporal Turbo Channel Coding/Decoding according to another embodiment of the present invention, wherein both the transmitter and the receiver have multiple antennas.

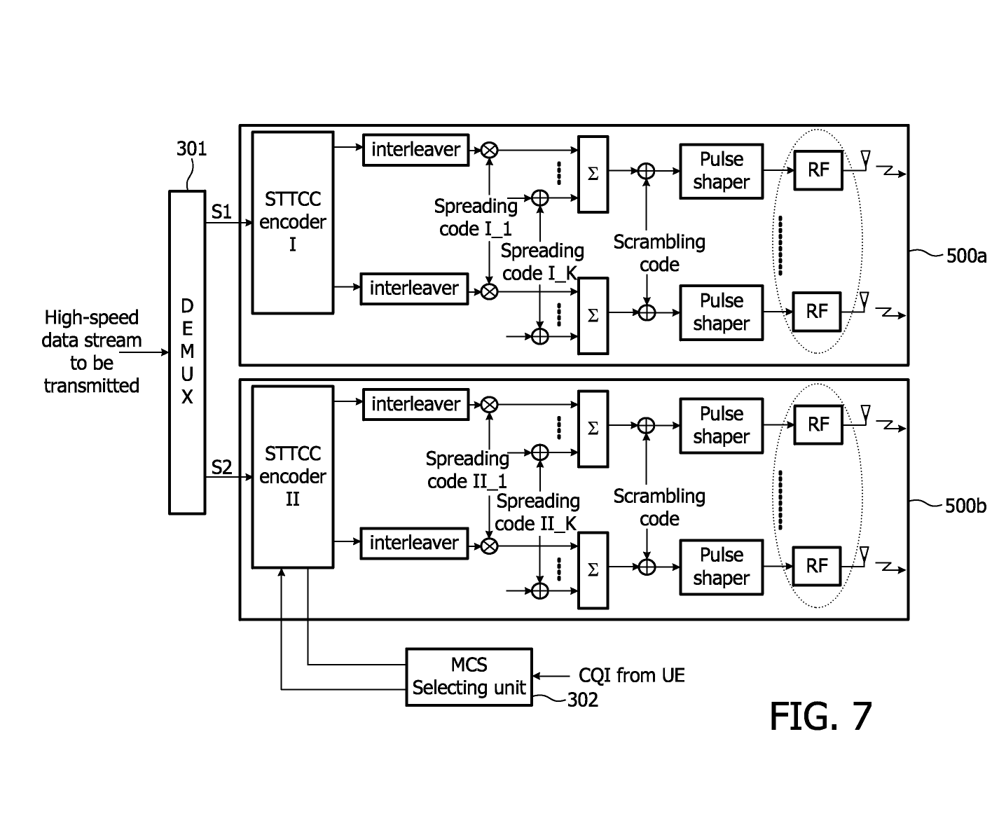

FIG. 7 is a schematic diagram illustrating the structure of the multiple antennas transmitter that adopts per-antenna group rate control scheme according to the present invention.

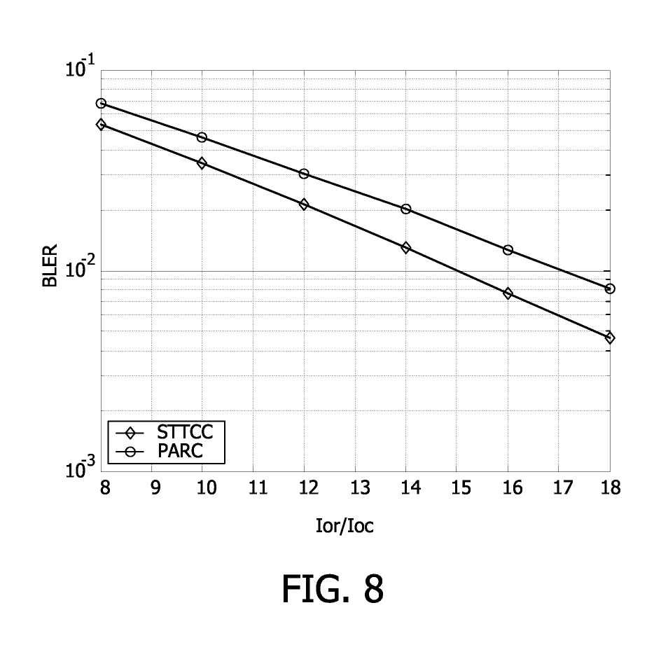

FIG. 8 is a graph illustrating the simulation results for the system adopting STTCC according to the present invention and the existing PARC system.

Throughout the drawing Figures, like reference numerals will be understood to refer to like parts and components.

### DETAILED DESCRIPTION OF THE INVENTION

In 3GPP HSPDA system, Turbo encoding technology is widely regarded as a channel encoding scheme. Combination of Turbo encoding and MIMO such as PARC or MPD has witnessed broad applications in the HSPDA system.

The present invention proposes a Spatial Temporal Turbo Channel Coding (STTCC) method for 3GPP HSPDA system, which can effectively combine Turbo encoding and MIMO together.

The case where the receiver in receiving side has only one receive antenna in 3GPP FDD system will be taken as an example below to detailedly describe the STTCC method proposed by the present invention and its applications in the system.

FIG. 1 is a schematic diagram illustrating the structure of the transmitter (e.g. base station) and the receiver (e.g. user terminal) adopting the STTCC method proposed by the present invention. In the transmitter 500, a high speed data stream to be transmitted will be sent to a STTCC encoder 510 for spatial temporal Turbo channel encoding, wherein the detailed structure of the STTCC encoder 510 will be depicted in FIG. 2-4. The high speed data stream to be transmitted will be processed in the STTCC coder 510 and converted into multiple parallel encoded substreams, and then the encoded signals of each parallel substream will sequentially pass through an interleaver 102 for interleaving, a spreading unit 103 for spreading (e.g. spreading by orthogonal variable spreading factor (OVSF) code), a multiplexer 105 for combining multiple channels, a scrambling unit 106 for scrambling the combined signals, a pulse shaper 107 for pulse shaping the scrambled signals and a RF unit 108 for modulating to form multiple parallel RF signals and will be finally transmitted by multiple antennas.

The above multiple parallel RF signals reach the receiver 600 at user terminal via wireless channels. In the embodiment, the receiver 600 has only one receive antenna. The signals received by the receiver 600 are the superposition of all the multiple signals transmitted via multiple parallel spatial channels. The RF signals received by the antenna are converted into baseband signals in a RF unit 208 and sent to a root raised cosine (RRC) filter and oversampling unit 206 for converting analog signals into discrete signals. The obtained discrete signals will then sequentially pass through a de-spreading and de-scrambling unit 204 for de-spreading and de-scrambling and a de-interleaver 202 for de-interleaving before sent to a STTCC decoder 610. The channel estimation unit 220 performs estimation on channel characteristics of the multiple parallel spatial channels according to pilot signals received. Subsequently, the STTCC encoder 610 utilizes the channel characteristics of the multiple channels estimated by the channel estimation unit 220 to perform corresponding decoding on the summed signals that are de-interleaved, so that the summed multiple parallel signals are decoded respectively and simultaneously the multiple parallel signals are converted into a serial data stream, namely the data required by user. The detailed structure and processing of the STTCC decoder 610 will be described below in conjunction with FIGS. 5-6.

FIG. 2 is a functional block diagram illustrating the above STTCC decoder 510. Wherein, it is assumed that the required data rate is L bit/symbol. As shown in FIG. 2, the information bit vector B=[b₁, . . . , b_{L}] outputted after a high-speed data stream to be transmitted undergoes serial/parallel (S/P) conversion goes through three paths respectively.

In the first path, the information bit vector B is directly sent into a modulation mapping unit 41. Through modulation mapping, Φ[B]=[s₁, . . . , s_{U}] can be utilized to acquire corresponding systematic bits, where Φ[•] is a function of mapping binary integer values into the transmitted symbols. For instance, when quadrature phase shift keying (QPSK) modulation is used, U=L/2. Systematic bits can be used to enable decoder to achieve better performance.

In the second path, the information bit vector B is firstly coded by an recursive encoder 21 and then D=[d₁, . . . , d_{M}] is outputted. Subsequently if the rate matching is required, D will be converted to C=[c₁, . . . , cₚ] by a rate matching unit 31. Wherein, the rate matching may be a puncturing processing at higher data rate, or a padding processing at lower data rate. According to the system requirement for data transmission rate, the puncturing/padding processing on the outputs of the recursive encoders 21, 22 carried out by the rate matching units 31, 32 includes deleting/adding bit symbols at some specified locations for rate matching purpose. Of course, if the requirement for data transmission rate is relatively low/high, the outputs of the recursive encoders 21, 22 are sent directly to subsequent units for processing without being carried out the puncturing/padding process. Finally, after modulation mapping, Φ[C]=[sᵤ₊₁, . . . , s_{N}] is utilized to obtain the encoded parity bits symbol, where N denotes the number of transmit antennas.

In the third path, the information bit vector B is firstly interleaved by an interleaving unit 10, and then similar to the processing of the second path, sequentially passes through the recursive encoder 22, the rate matching unit 32 and the modulation mapping unit 43 before the encoded parity bits symbol [s′ᵤ₊₁, . . . , s′_{N}] is obtained eventually.

The encoded symbols outputted from the second path and the third path are selectively outputted by a multiplexer 50 according to different times. For instance, at time t1, [sᵤ₊₁, . . . , s_{N}] is outputted by the multiplexer 50, while at next time t2, [s′ᵤ₊₁, . . . , s′_{N}] is outputted by the multiplexer 50.

Finally, [s₁, . . . , s_{N}] is transmitted alternately through a cycle switch 60 via different transmit antennas.

The above recursive encoders 21, 22 have the same generation matrix. The interleaving unit 10 carries out odd-even symbol interleaving process, which maps even symbols to even symbol positions, and odd ones to odd ones. Here, one symbol means L bits in vector B.

In order to obtain different structures of decoder, a de-interleaving unit may be added to the STTCC encoder at transmitter. As shown in FIG. 2, in the third path, the encoded symbol S=Φ[C′]=[s′ᵤ₊₁, . . . , s′_{N}] outputted from the modulation mapping unit 43 may be de-interleaved by a de-interleaving unit 70 and then sent to the multiplexer 50.

FIG. 3 is the detailed structure of the STTCC encoder designed based on the general structure of the STTCC encoder shown in FIG. 2. In order to simply the illustration to reflect the design concept more clearly, it is assumed that the number of transmit antennas is 2, the modulation mode is QPSK and the code rate is ½, the structure of the STTCC encoder is hereafter shown in FIG. 3. Wherein path 1 is used to process b1 and b2 so as to obtain systematic bits symbol, and no encoder is used on the path. Path 2 carries out recursive encoding on b1 and b2 respectively. Since the code rate is ½, the processing of the puncturing/padding unit 31′ in the path may be not required in the embodiment. Similarly to path 2, path 3 performs respectively recursive encoding on b1 and b2 processed by the interleaving unit 10, and the processing of the puncturing/padding unit 32′ in the path may be not required. The symbol s2 outputted selectively by the multiplexer 50 from the parity bits outputted from path 2 and path 3 and the symbol s1 outputted from path 1 are fed to the cycle switch 60, and eventually transmitted via two transmit antennas alternately, that is, at a time the symbol s1 is transmitted via the first transmit antenna, and the symbol s2 via the second transmit antenna; at next time, the symbol s1 is transmitted via the second transmit antenna, and the symbol s2 via the first transmit antenna Finally, the symbol on each path is transmitted via each of transmit antennas.

FIGS. 4 and 5 show respectively the structure of the STTCC decoders corresponding to the STTCC encoders with a de-interleaving unit 70 and without a de-interleaving unit 70. Wherein, the decoding units in the STTCC decoder are the symbol MAP (Maximum A Posteriori) decoders 91, 92, which employ an iterative algorithm to perform decoding on relating code sequences.

Specifically, as shown in the FIG. 4, after separated by a demultiplexer (DEMUX) 80, the received signals pass through a symbol MAP decoder 91, an interleaving unit 121, a symbol MAP decoder 92 sequentially and then go back the symbol MAP decoder 91 via a de-interleaving unit 111 to be decoded circularly and iteratively. After decoded iteratively several times, the better performance may be achieved. Wherein, the decoded signals outputted by the symbol MAP decoder 92 are sent to the symbol MAP decoder 91 as feedback information after de-interleaved by the de-interleaving unit 111, and the symbol MAP decoder 91 decodes the separated received signals based on the feedback information; the decoded signals outputted by the symbol MAP decoder 91 are sent to the symbol MAP decoder 92 as feedback information after interleaved by the interleaving unit 121, and the symbol MAP decoder 92 decodes the separated signals from the interleaving unit 122 based on the feedback information, so as to realize iterative decoding between the symbol MAP decoders 91 and 92. Finally, outputs of the symbol MAP decoder 92 pass through the de-interleaving unit 112 to obtain the decoded signals. Wherein the symbol MAP decoders 91 and 92 perform corresponding decoding by the channel characteristics obtained by the channel estimation unit 220.

As shown in FIG. 5, if there is not the de-interleaving unit 50 in the corresponding STTCC encoder, for the STTCC decoder, since symbol level code sequences are processed and outputted by the symbol MAP decoders 91, 92, the corresponding Sym/Bit conversion unit and Bit/Sym conversion unit are needed between the symbol MAP decoders 91, 92 and the de-interleaving unit 113/interleaving unit 123, so that the de-interleaving unit 113 and interleaving unit 123 can conduct bit level interleaving.

The case where the transmitter 500 has multiple transmit antennas while the receiver 600 has only one receive antenna is described above in conjunction with FIG. 1-5. Apparently, the method proposed by the present invention is not limited to the case, and can be applied to the case where the receiver has multiple antennas.

FIG. 6 shows the structure of the transmitter with multiple transmit antennas and the receiver with multiple receive antennas according to the present invention. Compared with FIG. 1, the receiver 700 in FIG. 6 has multiple receive antennas, and accordingly includes multiple receive processing paths. The structure of each receive processing path is the same as that of the single receiving antenna shown in FIG. 1, including a RF unit 208, a RRC filter and oversampling unit 206, a de-spreading and de-scrambling unit 204, a de-interleaver 202 and a channel estimation unit 220. Both the received signals processed by each of the receive processing paths and the channel characteristics estimated by the channel estimation unit 220 in each of the receive processing paths are sent to the STTCC decoder 710 for decoding. Different from the single receiving antenna, when the spatial channel decoding structure 710 performs decoding, it may weigh and sum up multiple path received signals in the symbol MAP decoding units to get the optimal decoded signals. It is obvious that the receiving diversity gain can be improved by using multiple antennas in receiver and the signals' BER can be reduced. Therefore, when the receiver has multiple receive antennas, the code rate of STTCC can be increased to further improve the transmission data rate.

In order to enable the transmission data rate to adapt flexibly the dynamic channel environment by the feedback information at receiving side, so as to achieve higher data transmission throughput, the rate control is applied widely to the MIMO solution in 3GPP HSDPA system. In the present invention, the rate control of the systems adopting STTCC can be implemented by the following schemes.

In the first scheme, the data transmission rate is control by using the rate matching of the STTCC encoder. In practical applications, the structure of STTCC may be designed based on the requirements of data transmission rate and the number of real transmit (Tx) antennas and receive (Rx) antennas. Table 1 lists the maximum code rate and spectrum efficiency of STTCC under different antenna configurations and modulation modes. From the table, it is noticed that the appropriate selection of the STTCC structure based on the requirements of Tx antenna, data transmission rate and modulation mode in practical systems, can achieve higher rate data transmission under the limited conditions of user terminals.

TABLE 1
STTCC modulation mode, code rate and spectrum efficiency
under different Tx and Rx antennas configuration.

| | | | Spectrum |
|---|---|---|---|
| | | | efficiency |
| (Tx, Rx) | Code rate | Modulation mode | (bit/s/Hz) |
| (2, 1) | ½ | QPSK | 2 |
| (2, 1) | ½ | 16 QAM | 4 |
| (4, 1) | ½ | QPSK | 4 |
| (4, 1) | ½ | 16 QAM | 8 |

In the second scheme, the Per Antenna Group Rate Control technique is adopted. As shown in FIG. 7, multiple transmit antennas and corresponding transmit processing paths in the transmitter are divided into two groups, namely transmit antenna groups 500a and 500b, each of which comprises a STTCC encoder. After demultiplexed by a demultiplexer (DEMUX) 301, the high-speed data stream to be transmitted is sent to the STTCC encoders I and II in the transmit antenna groups 500a, 500b respectively. The transmitter also comprises a modulation and coding scheme (MCS) selecting unit 302, which is used to select modulation and encoding schemes of the STTCC encoder I and II based on the Channel Quality Indication (CQI) from a user equipment (UE), for example, selecting QPSK (or 8PSK or 16PSK) to transmit data based on the condition of the data rate fed back from UE (namely, the condition of wireless environment where UE resides).

FIG. 7 shows the case of only two transmit antenna groups in the per antenna group rate control scheme, but in practical applications, the different number of transmit antenna groups may be selected and adopted according to different system requirements. The grouping method of the transmit antenna groups in the per antenna group rate control scheme according to the present invention can be further divided into two cases to discuss.

In the first case, when the receiver has only one receive antenna, each transmit antenna group uses a different spreading code so as to distinguish the different transmit antenna groups. Under this condition, the transmit antennas may be grouped freely according to practical requirements.

In the second case, when the receiver has multiple receive antennas, each transmit antenna group use the same spreading code and descrambling code, and the multiple receiver antennas distinguish different transmit antennas groups based on the spatial channel characteristics of MIMO. Under this condition, the number of transmit antenna groups should be less than or equal to the number of receive antennas. Besides, theoretically speaking, in a case where there are multiple receive antennas, the different transmit antenna groups may also be distinguished by the combination of different spreading codes or descrambling codes, under this condition, the number of transmit antenna groups is not limited to the number of receive antennas.

According to the above detailed description of the embodiment of the present invention in conjunction with the Figures, it is concluded that compared with the SCC technology, the STTCC technology proposed by the present invention can achieve better decoding performance in the receiver side due to the combination of Turbo encoding structure.

In existing technologies like PARC for the 3GPP HSPDA system, since the transmit path of each transmit antenna in PARC uses an independent Turbo encoder, it is impossible to utilize transmission diversity in the system. However, in the STTCC technology proposed by the present invention, each information bit will be transmitted via the transmit path of each transmit antenna, therefore the better performance may be achieved under the same frequency efficiency.

In order to verify the advantage of the STTCC technology proposed by the present invention over PARC, the scheme adopting STTCC and the one adopting PARC are simulated by the parameters shown in table 2, and the simulation results are shown in FIG. 8. It can be found that under BLER is 10-2, the Ior/Ioc (i.e., the ratio of the average power of all transmitted signals to the average power of all noises and interferences in the current cell and neighboring cells) of the scheme adopting STTCC is about 2 dB lower than that of the one adopting PARC.

TABLE 2
simulation parameters

| Parameter/feature | Value/description |
|---|---|
| Code rate | 3.84 MHz |
| Modulation mode | QPSK |
| Spreading factor | 16 |
| Channel Number | 10 |
| Timeslot | 3 |
| Code length (ns) | 260 |
| Channel Encoder | PARC: Concatenated Turbo encoder, |
| | code rate ½; |
| | STTCC: code rate ½, increasing |
| | de-interleaving unit |
| Decoding iterative number | 4 |
| Interleaver | Random interleaving |
| Tx | 2 |
| Rx | 2 (PARC); 1 (STTC) |
| Synchronization | Ideal synchronization |
| Service mapping | The combination of multiple codes and |
| | multiple timeslots. |
| Sampling number per ship | 4 |

Moreover, the rate control may be realized flexibly to facilitate the practical applications according to the STTCC method and system proposed by the present invention.

It is to be understood by those skilled in the art that the spatial temporal channel coding method and apparatus disclosed in present invention may be made of various modifications without departing from the spirit and scope of the invention as defined by the appended claims.

1. A channel coding method, comprising the steps of:
(a) Converting serial signals to be encoded into multiple parallel signals;
(b) Interleaving the multiple parallel signals;
(c) Encoding the multiple parallel signals and the interleaved multiple parallel signals respectively according to a predefined coding rule, to obtain encoded multiple parallel signals; and
(d) Transmitting the encoded multiple parallel signals and the multiple parallel signals alternately and cyclically via multiple transmit antennas.

2. The channel coding method according to claim 1, wherein the predefined coding rule is a recursive encoding.

3. The channel coding method according to claim 1, wherein the step (c) further comprising:
(c1) Performing rate matching on the encoded multiple parallel signals.

4. The channel coding method according to claim 3, wherein the rate matching comprises a puncturing/padding process.

5. The channel coding method according to claim 1 wherein the step (c) further comprising:
(c2) Performing modulation mapping on the multiple parallel signals and the encoded multiple parallel signals in the step (a) respectively according to a predefined modulation mode.

6. The channel coding method according to claim 5, wherein the step (d) comprising:
Multiplexing the encoded multiple parallel signals that are modulation mapped; and
Performing cycle switching on the multiplexed encoded multiple parallel signals and the multiple parallel signals in the step (a) so as to output the signals alternately and circularly to the multiple transmit antennas.

7. The channel coding method according to claim 5, wherein the step (c2) further comprising:
On the encoding path that encodes the interleaved multiple parallel signals, performing de-interleaving on the encoded multiple parallel signals that are modulation mapped

8. The channel coding method according to claim 1, wherein the modulation mode is QPSK.

9. A channel decoding method, comprising the steps of:
a) Demultiplexing encoded multiple parallel signals received via at least one receive antenna;
b) Performing channel estimation on multiple wireless channels on which the encoded multiple parallel signals are transmitted; and
(c) Performing recursive decoding on the demultiplexed encoded multiple parallel signals by using the channel estimation result and according to a predefined decoding rule.

10. The channel decoding method according to claim 9, wherein when the encoded multiple parallel signals are received via multiple receive antennas, the step (c) comprising:
Weighing the encoded multiple parallel signals received via the multiple receive antennas by utilizing the channel estimation result; and
Performing recursive decoding on the weighed signals according to the predefined decoding rule.

11. The channel decoding method according to claim 9, wherein the step (c) comprising:
(c1) Performing first decoding on the demultiplexed encoded signals according to the predefined decoding rule, to output the signals that are first decoded; and
(c2) Performing second decoding on the signals that are first decoded according to the predefined decoding rule, to output the final decoded signals.

12. The channel decoding method according to claim 11, wherein the step (c) further comprising:
Interleaving the signals that are first decoded; and
De-interleaving the final decoded signals.

13. The channel decoding method according to claim 11, wherein the step (c1) further comprising:
Performing first decoding on the demultiplexed encoded signals according to the predefined decoding rule and the final decoded signals, so as to improve correction accuracy through the circular and recursive decoding.

14. The channel decoding method according to claim 11, wherein the predefined decoding rule is symbol MAP (Maximum A Posterior) decoding.

15. A channel coder, comprising:
A converting means, for converting serial signals to be encoded into multiple parallel signals and outputting the multiple parallel signals;
An interleaving means, for interleaving the multiple parallel signals outputted from the converting means and outputting the interleaved multiple parallel signals;
A first-encoding means, for encoding the multiple parallel signals outputted from the converting means according to a predefined coding rule and outputting the encoded multiple parallel signals;
A second-encoding means, for encoding the interleaved multiple parallel signals outputted from the interleaving means according to the predefined coding rule; and
A transmitting device, for transmitting the encoded multiple parallel signals outputted from the first-encoding means and the second-encoding means and the multiple parallel signals outputted from the converting means via multiple transmit antennas circularly and alternately;

16. The channel encoder according to claim 15, wherein the first-encoding means and the second-encoding means are both recursive encoders.

17. The channel encoder according to claim 15, further comprising:
A first-mapping means, for performing modulation mapping on the multiple parallel signals outputted from the converting means;
A second-mapping means, for performing modulation mapping on the encoded multiple parallel signals outputted from the first-encoding means; and
A third-mapping means, for performing modulation mapping on the encoded multiple parallel signals outputted from the second-encoding means;

18. The channel encoder according to claim 17, further comprising:
A multiplexing means, for multiplexing the multiple parallel signals outputted from the second-mapping means and the third-mapping means.

19. The channel encoder according to claim 15, comprising:
A first rate matching means, for performing puncturing/padding process on the encoded multiple parallel signals outputted from the first-encoding means;
A second rate matching means, for performing puncturing/padding process on the encoded multiple parallel signals outputted from the second-encoding means.

20. The channel encoder according to claim 17, further comprising:
A de-interleaving means, for interleaving the multiple parallel signals outputted from the third-mapping means.

21. The channel encoder according to claim 17, further comprising:
A shifting means, for performing cycle switching on the multiple parallel signals outputted from the first-mapping means, the second-mapping means and the third-mapping means, to transmit the signals to the multiple transmit antennas circularly and alternately.

22. A channel decoder, comprising:
A demultiplexing means, for demultiplexing encoded multiple parallel signals received via at least one receive antenna;
An estimation means, for performing channel estimation on multiple wireless channels on which the encoded multiple parallel signals are transmitted;
A decoding means, for decoding the encoded multiple parallel signals outputted from the demultiplexing means by using the channel estimation result and according to a predefined decoding rule.

23. The channel decoder according to claim 22, wherein when the encoded multiple parallel signals are received from multiple receive antennas, the channel decoder further comprising:
A weighing means, for weighing the encoded multiple parallel signals received via the multiple receive antennas by using the channel estimation result.

24. The said channel decoder according to claim 22, wherein the decoding means comprising:
A first-decoding means, for performing first decoding on the encoded multiple parallel signals outputted from the demultiplexing means according to the predefined decoding rule, and outputting the signals that are first decoded; and
A second-decoding means, for performing second decoding on the signals that are first decoded according to the predefined decoding rule, and outputting the final decoded signal.

25. The channel decoder according to claim 24, wherein the first-decoding means performs first decoding on the encoded signals outputted from the demultiplexing means according to the predefined decoding rule and the final decoded signals outputted from the second-decoding means, so as to improve correction accuracy through the circular and recursive decoding.

26. The channel decoder according to claim 24, wherein the predefined decoding rule is symbol MAP decoding.

27. A communication device, comprising:
A channel encoder, for performing channel coding on serial signals to be transmitted, so as to output encoded multiple parallel signals, and there is related redundancy information between the encoded multiple parallel signals;
Multiple transmit antennas, for transmitting the encoded multiple parallel signals circularly and alternately.

28. The communication device according to claim 27, wherein the channel encoder comprising:
A converting means, for converting the serial signals to be transmitted into multiple parallel signals and outputting the multiple parallel signals;
An interleaving means, for interleaving the multiple parallel signals outputted from the converting means and outputting the interleaved multiple parallel signals;
A first-encoding means, for encoding the multiple parallel signals outputted from the converting means according to a predefined coding rule and outputting the encoded multiple parallel signals;
A second-encoding means, for encoding the interleaved multiple parallel signals outputted from the interleaving means according to the predefined encoding rule; and
A transmitting means, for transmitting the encoded multiple parallel signals outputted from the first-encoding means and the second-encoding means and the multiple parallel signals outputted from the converting means via multiple transmit antennas circularly and alternately.

29. A communication terminal, comprising
At least one receive antenna, for receiving encoded multiple parallel signals, wherein the multiple parallel encoded signals is channel encoded and then transmitted via multiple transmit antennas, and there is related redundancy information between the multiple parallel encoded signals;
At least one channel estimation unit, for performing channel estimation on multiple wireless channels on which the encoded signals are transmitted according to received pilot signals; and
A channel decoder, for performing recursive decoding on the received signals by using the channel estimation result and according to the spatial channel codes.

30. The communication terminal according to claim 29, wherein the said channel decoder comprising:
A demultiplexing means, for demultiplexing the encoded multiple parallel signals received via the at least one receive antenna;
An estimating means, for performing channel estimation on multiple wireless channels on which the encoded multiple parallel signals are transmitted;
A decoding means, for performing recursive decoding on the encoded multiple parallel signals outputted from the demultiplexing means by using the channel estimation result and according to a predefined decoding rule.

31. The communication terminal according to claim 30, wherein the predefined decoding rule is symbol MAP decoding.
